(19) United States
(12) Patent Application Publication
(10) Pub. No.: US 2015/0052164 A1
(43) Pub. Date: Feb. 19, 2015

(54) ASSOCIATING AN APPLICATION WITH AN APPLICATION FILE

(71) Applicant: HEWLETT-PACKARD DEVELOPMENT COMPANY L.P., HOUSTON, TX (US)

(72) Inventors: Vitaly Miryanov, Richmond Surrey TW9 (GB); Xiang Tan, Shanghai (CN); Shuanglin Tang, Shanghai (CN)

(21) Appl. No.: 14/388,177

(22) PCT Filed: Mar. 30, 2012
(86) PCT No.: PCT/CN2012/073285

§ 371 Date: Sep. 25, 2014

(51) Int. Cl. G06F 17/30

(52) U.S. Cl. CPC G06F 17/30082; G06F 17/30115
USPC 707/758

(57) ABSTRACT

An association method includes identifying candidate file sets from a plurality of application files. Content indicative of each of the candidate file sets is presented. An application is associated with application files of one of the candidate file sets according to a detected selection of the content indicative of that candidate file set.

### BACKGROUND

A software discovery product maintains a database/library of known software applications. The application library records a list of application files, including their attributes that make up these applications as well as other data such as rules for making associations. This application library allows the product to process the raw file and directory data collected during software inventory and identify which files belong to known applications. Using these associations, the discovery product can identify an inventory of installed applications within a specified environment. The maintenance of an application library can be very time consuming, so it often only recognizes a limited number of applications. As a result, a large number of application files from a raw file inventory often remain unrecognized. The analysis of which applications these unrecognized files belong to is challenging and resource consuming as files are manually sifted through one by one.

### DRAWINGS

FIG. 1 depicts an environment in which various embodiments may be implemented.

FIG. 2 depicts a system according to an example,

FIG. 3 is a block diagram depicting a memory and a processing resource according to an example.

FIG. 4 is a flow diagram depicting steps taken to implement an example.

FIG. 5 is depicts a graphical user interface in which content indicative of identified frequent file sets is displayed according to an example.

### DETAILED DESCRIPTION

### Introduction

Software discovery products are often unable to recognize all the application files of the computing devices the products manage. In other words, the software discovery products are not able to associate all of the application files of those computing devices with their corresponding applications. Various embodiments described below were developed to more efficiently associate unrecognized application files with their corresponding applications.

In an example implementation, an unrecognized application file can be associated with an application in the following manner. Candidate file sets are identified from a plurality of unrecognized application files. The relation can be identified using one of any number of approaches. For example, as will be explained in more detail below, a candidate file set may be a frequent file set, a common application package file set, a common version file set or a common directory file set. Content indicative of each of the candidate file sets is presented. Presentation, for example, can include causing a display of the content in a user interface. Presentation can also include communicating the content electronically so that it can be analyzed in an automated fashion. An application is associated with application files of one of the candidate file sets according to a detected selection of the content indicative of that candidate file set. A candidate file set is a set of related application files occurring on one or more computing device being managed or otherwise monitored.

The following description is broken into sections. The first, labeled “Environment,” describes an example network environment in which various embodiments may be implemented. The second, labeled “Components,” describes examples of physical and logical components for implementing various embodiments. The third section, labeled “Operation,” describes steps taken to implement various embodiments.

### Environment

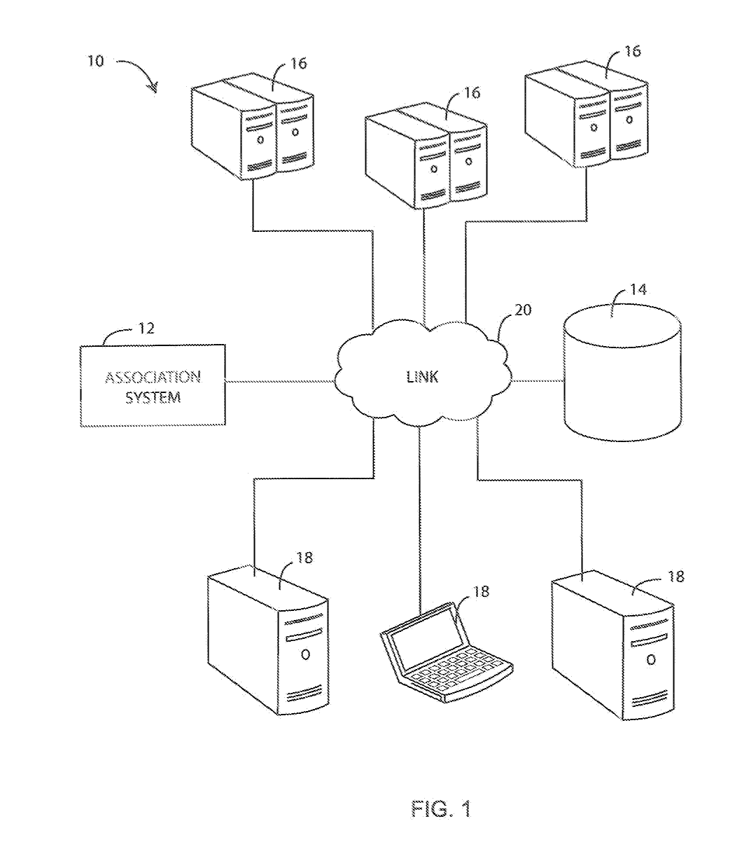

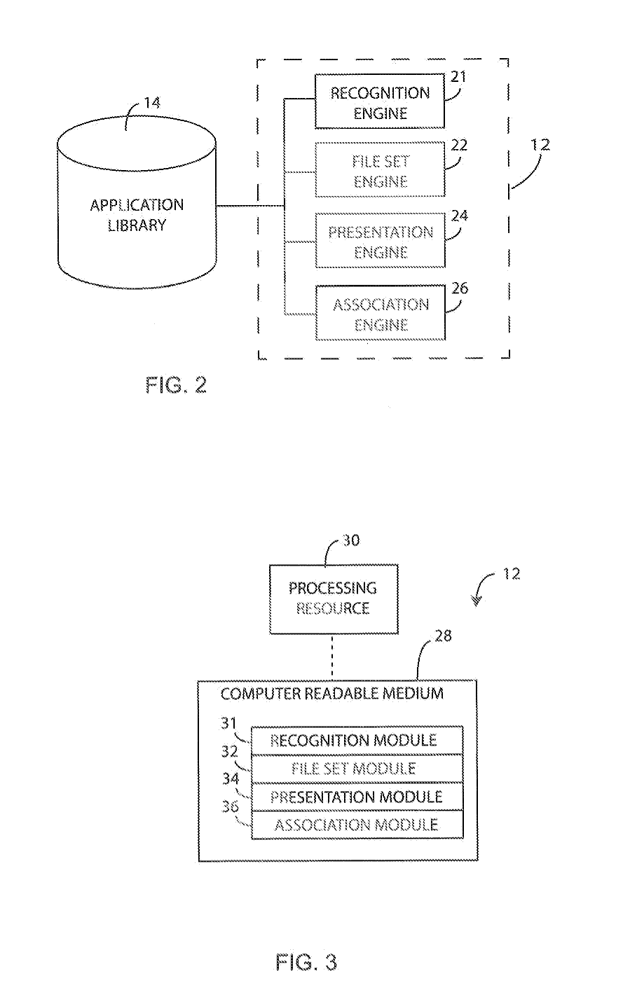

FIG. 1 depicts an environment 10 in which various embodiments may be implemented. Environment 10 is shown to include association system 12, data store 14, server devices 16, and client devices 18. Association system 12, described below with respect to FIGS. 2 and 3, represents generally any combination of hardware and programming configured to associate application files with their corresponding applications. Data store 14 represents generally any device or combination of devices configured to store data used by association system in the performance of its tasks. Such data can include an application library identifying application files of one or more of server devices 16 and client devices 18. The application library is used to identify associations between application files and their corresponding applications. The library can also be used to identify unrecognized application flies of devices 16 and 18, that is, application files whose application association is not presently known.

Server devices 16 represent generally any computing devices configured to serve data for consumption by client devices 18. Server device 18 may function for example as web servers, application servers, and database servers. Various applications are accessible to and executable by server devices 16 enabling devices 16 to perform their respective functions. Client devices 18 represent generally any computing devices configured to request and consume data served by server devices 16. Various applications are accessible to and executable by client devices 18 enabling client devices 18 to perform their respective functions. The application files of those server device and client device applications may be discoverable by association system 12.

Component 12-18 are interconnected via link 20. Link 20 represents generally one or more of a cable, wireless, fiber optic, or remote connections via a telecommunication link, an infrared link, a radio frequency link, or any other connectors or systems that provide electronic communication. Link 20 may include, at least in part, an intranet, the Internet, or a combination of both. Link 20 may also include intermediate proxies, routers, switches, load balancers, and the like.

### Components

FIGS. 2-3 depict examples of physical and logical components for implementing various embodiments. FIG. 2 depicts association system 12 in communication with data store 14. Data store 14 is shown as containing an application library for use by system 12 to associate application files with their corresponding applications. In the example of FIG. 2, system 12 includes recognition engine 21, file set engine 22, presentation engine 24, and association engine 26. Recognition engine 21 operates to identify application files in an environment, and file set engine 22 operates to group those unrecognized files into clusters according to one or more grouping techniques. Presentation engine 24 operates to present content indicative of each cluster, while association engine 26 serves to associate an application with a cluster's application files according to a detected selection of the content indicative of that cluster.

More particularly, recognition engine 21 represents generally any combination of hardware and programming configured to identify an environment's application files. Recognition engine 21 may operate by scanning application library 14 to identify applications noted in library 14 and their known associations with specified applications. Where application library 14 includes rules, recognition engine 21 applies these rules to identify applications associated with application files present in the environment. By identifying those application files associated with the specified applications, recognition engine 21 can also identify unrecognized application files. That is, recognition engine 21 can identify those application files whose application associations are not known.

File set engine 22 represents generally any combination of hardware and programming configured to identify candidate file sets from a plurality of application files where each candidate file set includes a cluster of related but unrecognized application files. As described below such candidate file sets can be frequent file sets, common application package file sets, common version file sets, and common directory file sets. In other words, file set engine 22 may identify unrecognized application files as being related using a number of techniques.

In one approach, file set engine 22 identifies candidate file sets that are frequent file sets. A frequent file set is a set of unrecognized application files occurring on two or more computing devices in the environment. In doing so, file set engine 22 may detect unrecognized application files of a number of computing devices. File set engine 22 may select all the unrecognized files that have occurred on more than one computing device, group them by platform and Computer ID, and sort by the filename. The unrecognized application files may also be sorted by file size. From that listing, file set engine 22 may construct a frequent pattern tree to identify frequent file sets.

A frequent pattern tree is a data structure representing quantitative information about frequent patterns found within the set of unrecognized files. Here that quantitative information identifies unrecognized application file names and the computing devices on which each unrecognized application file was found. From that data structure, sets of application files occurring on two or more computing devices can be identified. These sets are frequent file sets in that they occur on more than one computing device. In other words, frequent file sets are clusters of two or more unrecognized application files occurring on two or more computing devices.

As noted, file set engine 22 may use a number of techniques to identify candidate file sets. Instead of focusing on frequent file sets, file set manager 22 may identity candidate file sets that are common application package file sets. A common application package file set is a collection of application files that belong to the same application package. Application package information gleaned from an application file may identify a publisher, a name, and a version. Here, file set manager 22 identifies the unrecognized application files that share the same application package information and clusters those into common application package file sets.

In another example, file set manager 22 may identify candidate file sets that are common version file sets. A common version file set is a collection of application files that have the same version data found in their version resources. File set engine 22 may glean version information from the unrecognized files and identify those application files that share the same version. File set engine 22 can than cluster those application files into common version file sets.

In another example, file set manager 22 may identify candidate file sets that are common directory file sets. A common directory file set is a collection of application files that belong to the same sub-directory tree of a file system. File set engine 22 may glean directory information from the unrecognized files and identify those application files that share the same sub-directory tree. File set engine 22 can then cluster those application files into common directory file sets. Note that files that share a common sub-directory tree need not share a common full directory path. For example, the directory path “C:\Program Files (x86)\Internet Explorer\file.ext” differs from “D:\Program Files\Internet Explorer\file.ext. However the two share a common subdirectory tree—\Internet Explorer\file.ext.”

A candidate file set, regardless of form, can be quantified by its support and its size. The number of instances of the candidate file set is called the support. That is, the support for a candidate file set represents the number of computing devices on which the same set of application files occurs. The size of a candidate file set represents the number of application files included in the set. In performing its function, file set engine 22 may be tasked with identifying candidate file sets having a support exceeding a predetermined threshold. File set engine 22 may identify candidate file sets of sizes exceeding another predetermined threshold.

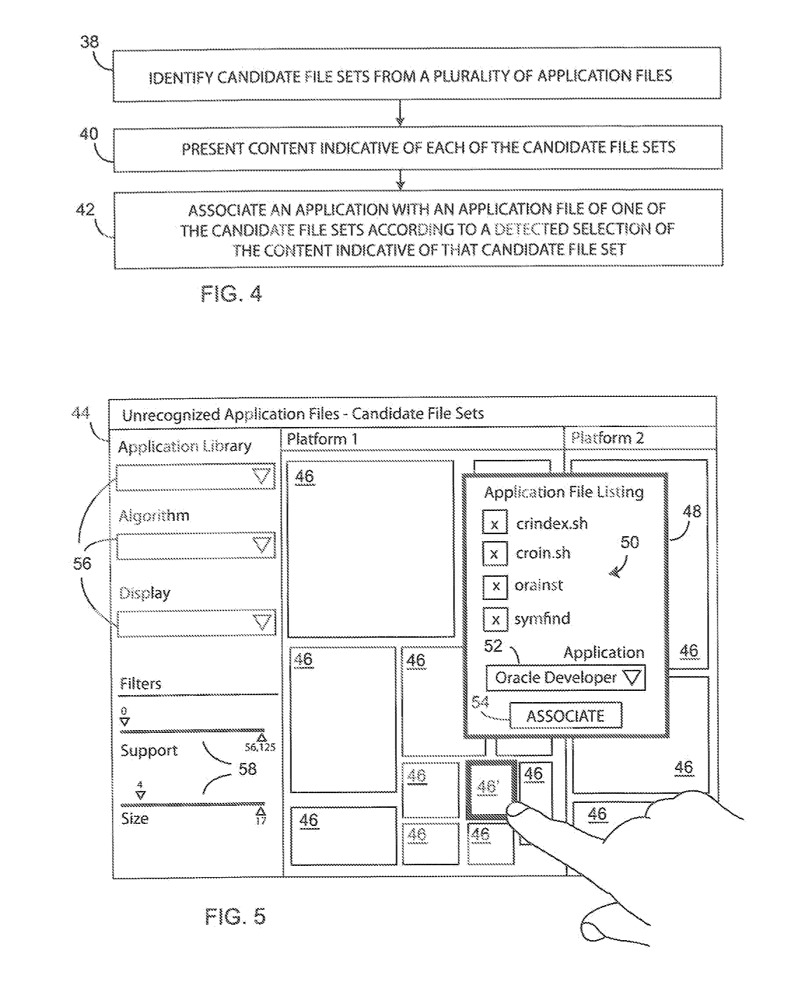

Presentation engine 24 represents generally any combination of hardware and programming configured to present content indicative of each of the candidate file sets identified by file set engine 22. The term content is defined by the manner in which the content is presented. Presentation engine 22 may present content in any of a number of fashions. In one example, content may be presented as graphical or textual content to be displayed for viewing and selection by a user. FIG. 5, discussed below depicts an example of graphical content that may be selected by a user. In another example, content may be electronic data communicated to and analyzed by a computing device. That computing device can, in an automated fashion, examine and select from the content based on the examination.

As noted, content is indicative of a corresponding candidate file set. In other words, content may be indicative of the support and size of its corresponding candidate file set. If content is to be displayed, its display may reflect the contents, support, and size of the corresponding candidate file set allowing the user to distinguish and select from among the candidate files sets. If the content is to be communicated for automated analysis, the corresponding electronic data may identify the contents, support, and size of each corresponding candidate file set allowing the computing device to distinguish and select from among between candidate file sets.

Association engine 26 represents generally any combination of hardware and programming configured to associate an application with a candidate file set according to a detected selection of the content indicative of that candidate file set. In performing this task, association engine 26 may perform the association by adding the application files of the candidate file set to application library 14 or by creating a rule to identify the files in the candidate file set and then adding the rule to application library 14. In other words, following detection of content presented by presentation engine 24, association engine 26 associates an application with one or more application files of the candidate file set indicated by the selected content. The application may, for example, be identified manually by a user viewing the content presented by presentation engine 22 or in an automated fashion by a computing device to which the content is presented. Detection of content selection can include receiving a communication indicative of a user's selection of displayed content. Detection can also include receiving a communication indicative of a computing device's automated selection of content.

As noted, association engine 26 may also be responsible for generating a rule based on an association established between an application and a candidate file set. The rule, for example, may specify that the application files of the given set belong to the associated application. For example, an installed package rule may associate files belonging to a particular package with an application. A version data rule may associate all files having a particular version data with an application. Further, when performing matching for either package name or version data, regular expressions can be employed by the rules to allow for flexible association and to enable one rule to match more than one application version. When presented with another set of unrecognized application files, recognition engine 21 can process such rules to automatically recognize files of the other set as being associated with particular applications. Such rules may be stored as part of application library in data store 14 and be made accessible to other association systems.

In foregoing discussion, engines 21-26 were described as combinations of hardware and programming. Such components may be implemented in a number of fashions. Looking at FIG. 3, the programming may be processor executable instructions stored on tangible, non-transitory computer readable medium 28 and the hardware may include processing resource 30 for executing those instructions. Processing resource 30, for example, can include one or multiple processors. Such multiple processors may be integrated in a single device or distributed across devices. Medium 28 can be said to store program instructions that when executed by processor resource 30 implements system 12 of FIG. 2. Medium 28 may be integrated in the same device as processor resource 30 or it may be separate but accessible to that device and processor resource 30.

In one example, the program instructions can be part of an installation package that when installed can be executed by processor resource 30 to implement system 12. In this case, medium 28 may be a portable medium such as a CD, DVD, or flash drive or a memory maintained by a server from which the installation package can be downloaded and installed. In another example, the program instructions may be part of an application or applications already installed. Here, medium 28 can include integrated memory such as a hard drive, solid state drive, or the like.

In FIG. 3, the executable program instructions stored in medium 28 are represented as recognition module 31, file set module 32, presentation module 34, and association module 36 that when executed by processing resource 30 implement association system 12 (FIG. 2). Recognition module 31 represents program instructions that when executed function as recognition engine 21. File set module 34 represents program instructions that when executed function as file set engine 22. Presentation module 36 represents program instructions that when executed implement presentation engine 24. Association module 38 represents program instructions that when executed implement association engine 26.

### Operation

FIG. 4 is a flow diagram of steps taken to implement a method for identifying push communications. In discussing FIG. 4, reference may be made to the diagrams of FIGS. 1-3 to provide contextual examples. Implementation, however, is not limited to those examples. In step 38, candidate file sets are identified from a plurality of application files. The plurality of application files, for example, may be unrecognized files that have not been associated with an application. Referring back to FIG. 2, file set engine 22 may be responsible for implementing step 38 by examining a plurality of application files not recognized by recognition engine 21.

As noted earlier, a candidate file set is a group of files determined to be related through the use of a grouping technique. For example, depending on the particular grouping technique employed, candidate file sets identified in step 38 can include at least one of a frequent file set, a common application package file set, a common version file set, and a common directory file set. When identifying candidate file sets that are frequent file sets, step 38 can include detecting unrecognized application files of a number of computing devices, grouping those files by platform and Computer ID and sorting them by the filename. The unrecognized application files may also be sorted by file size. Step 38 can include constructing a data structure (such as a frequent pattern tree) from the resulting list of unrecognized application files and identifying the frequent file sets from that data structure.

As noted, a candidate file set may be quantified by its support and its size. The number of instances of the candidate file set is called the support. That is, the support for a candidate file set represents the number of computing devices on which the same set of application files occurs. The size of a candidate file set represents the number of application files included in the set. Step 38 can include identifying candidate file sets having a support exceeding a first predetermined threshold and candidate file sets of sizes exceeding a second predetermined threshold

With the candidate file sets identified in step 38, content indicative of each of the candidate file sets is presented in step 40. Referring back to FIG. 2, presentation engine 24 may implement step 40. As previously noted, the term content is defined by the manner in which the content is presented. Step 40 may include presenting content in any of a number of fashions. In one example, content may be presented as graphical or textual content to be displayed for viewing and selection by a user. FIG. 5, discussed below depicts an example of graphical content that may be selected by a user. In another example, content may be electronic data communicated to and analyzed by a computing device. That other computing device can examine and select from the content based on the examination in an automated fashion.

Again, content is indicative of a corresponding candidate file set. In other words, content can be indicative of the support and size of its corresponding candidate file set. If content is to be displayed, its display may reflect the file contents, support, and size of the corresponding candidate file set allowing the user to distinguish and select from among the candidate files sets. If the content is to be communicated for automated analysis, the corresponding electronic data may identify the contents, support, and size of each corresponding candidate file set allowing the computing device to distinguish and select from among between candidate files sets.

Once the content is presented in step 40, an application is associated with an application file of one of the candidate file sets according to a detected selection of the content indicative of that candidate file set in step 42. In other words, following detection of content presented in step 40, an application is associated with one or more application files of the candidate file set indicated by the selected content. The association may be accomplished by adding the application files of the candidate file set to an application library. Such may include generating a rule to identify the files in the candidate file set and then adding the rule to application library.

The application may, for example be identified manually by a user viewing the content presented in step 40 or in an automated fashion by a computing device to which the content as presented in step 40. Detection of content selection can include receiving a communication indicative of a user's selection of displayed content. Detection can also include receiving a communication indicative of a computing device's automated selection of content. Referring back to FIG. 2, association engine 26 may implement step 42.

As noted, associating in step 42 can include generating a rule based on an association established between an application and a candidate file set can be generated. The rule, for example, may specify that the application flies of the given set belong to the associated application. Thus, when presented with another set of unrecognized application files, the rule can be processed to automatically associate files of the other set with the application.

As discussed, presentation of content indicative for identified candidate file sets can include causing a user interface to display that content. FIG. 5 depicts an example of such an interface 44. Interface 44 is shown to include content items 46. Each content item 46 is a presentation of content associated with a candidate file set. Here content items are shown as rectangles of various sizes. The size of each, for example, may be indicative of the support of the candidate file set the content item 46 represents. While not visible in FIG. 5, the color or other discernible attribute of each content item 48 may be indicative of the size of its corresponding candidate file set.

In the example of FIG. 5, a user has selected content item 46′ and in doing so can be said to have selected content indicative of a particular candidate file set. In response to the selection of content item 46′, a window 48 is displayed listing the application files 50 of that candidate file set. With each application file is a check box control allowing the user to remove one or more application files from the candidate file set. Control 52 allows the user to select an application to associate with the application files remaining the candidate file set. Control 54 allows the user to instruct that those application files be associated with the application identified using control 52.

Interface 44 is also shown to include controls 56 allowing the user to:
select an application containing the unrecognized application files being analyzed for association;
specify how the content items 46 are presented; and
specify an algorithm for use in identifying the candidate file sets.
   In an example the algorithm selected determines whether the identified candidate file sets are frequent file sets, common application package file sets, common version file sets, common directory file sets, or combinations thereof. Interface 44 is also shown to include filter controls 58 to limit the content that is presented. Here the filter controls 58 allow the user to specify a support range and a size range of the candidate file sets for which content items 46 are displayed.

### Conclusion

FIGS. 1-3 depict the architecture, functionality, and operation of various embodiments. In particular, FIGS. 2-3 depict various physical and logical components. Various components are defined at least in part as programs or programming. Each such component, portion thereof, or various combinations thereof may represent in whole or in part a module, segment, or portion of code that comprises one or more executable instructions to implement any specified logical function(s). Each component or various combinations thereof may represent a circuit or a number of interconnected circuits to implement the specified logical function(s).

Embodiments can be realized in any computer-readable medium for use by or in connection with an instruction execution system such as a computer/processor based system or an ASIC (Application Specific Integrated Circuit) or other system that can fetch or obtain the logic from computer-readable medium and execute the instructions contained therein. “Computer-readable medium” can be any individual medium or distinct media that can contain, store, or maintain a set of instructions and data for use by or in connection with the instruction execution system. A computer readable medium can comprise any one or more of many physical, non-transitory media such as, for example, electronic, magnetic, optical, electromagnetic, or semiconductor media. More specific examples of a computer-readable medium include, but are not limited to, a portable magnetic computer diskette such as floppy diskettes, hard drives, solid state drives, random access memory (RAM), read-only memory (ROM), erasable programmable read-only memory, flash drives, and portable compact discs.

Although the flow diagram of FIG. 4 shows a specific order of execution, the order of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present invention.

FIG. 5 provides an example of a user interface through which content indicative of candidate file sets can be presented. It is noted, that the user interface depicted is only an example. Content indicative of candidate file sets can be presented in any other number of available fashions.

The present invention has been shown and described with reference to the foregoing exemplary embodiments. It is to be understood, however, that other forms, details and embodiments may be made without departing from the spirit and scope of the invention that is defined in the following claims.

What is claimed is:

1. An association method, comprising:
identifying candidate file sets from a plurality of application files, each candidate file set including a cluster of related but unrecognized application files;
presenting content indicative of each of the candidate file sets; and
associating an application with application files of one of the candidate file sets according to a detected selection of the content indicative of the one of the candidate file set.

2. The method of claim 1, wherein the candidate file sets include at least one of a frequent file set, a common application package file set, a common version file set, and a common directory file set.

3. The method of claim 1, wherein identifying candidate file sets comprises constructing a frequent pattern tree from the found application files and identifying the candidate file sets that are frequent file sets from the frequent pattern tree.

4. The method of claim 1 wherein identifying candidate file sets comprises identifying candidate file sets having a support exceeding a predetermined threshold support.

5. The method of claim 1, wherein identifying candidate file sets comprises identifying candidate file sets of sizes exceeding a predetermined threshold size.

6. The method of claim 1, wherein, for each identified candidate file set, the content presented for that candidate file set is indicative of at least one of a support and a size of the candidate file set.

7. The method of claim 1, wherein the plurality of application files is a first plurality, the method comprising:
generating a rule based on the association between the application and its corresponding candidate file set; and
processing the rule to automatically associate unrecognized files of a second plurality of application files with the application.

8. A computer readable medium having instructions stored thereon that when executed by a processing resource implement a system comprising a file set engine, a presentation engine, and an association engine, wherein:
the file set engine is configured to examine a plurality of unrecognized files of two or more computing devices and identify candidate file sets from the plurality, each candidate file set including a cluster of related but unrecognized application files;
the presentation engine is configured to present content indicative of each identified candidate file set; and
the association engine is configured to detect a selection of content indicative of one of the candidate file sets and associate an application with an application file of that one of the candidate file sets.

9. The medium of claim 8, wherein the file set engine is configured to identify candidate file sets that include at least one of a frequent file set, a common application package file set, a common version file set, and a common directory file set.

10. The medium of claim 8, wherein the file set engine is configured to construct a data structure representing quantitative information about frequent patterns found within the set of unrecognized files and identify the candidate file sets that are frequent file sets from the data structure.

11. The medium of claim 8 wherein the file set engine is configured to identify candidate file sets having a support exceeding a predetermined threshold.

12. The medium of claim 8, wherein the file set engine is configured to identify candidate file sets of sizes exceeding a predetermined threshold.

13. The medium of claim 8, wherein, for each identified candidate file set, the presentation engine is configured to present content for that candidate file set that is indicative of at least one of a support and a file set size of the candidate file set.

14. The medium of claim 8, wherein:
the plurality of application files is a first plurality, wherein the association engine is configured to generate a rule based on the association between the application its corresponding candidate file set; and
the system includes a recognition engine configured to process the rule to automatically associate unrecognized files of a second plurality of application files with the application.

15. A system comprising a processing resource and a non-transitory computer readable medium and instructions stored on the medium, wherein the instructions, when executed, cause the processing resource to implement a method, comprising:
examining a plurality of unrecognized application files of two or more computing devices to identify candidate file sets from the plurality;
presenting content indicative of each of the candidate file sets; and
associating an application with the application files of a given one of the candidate file sets according to a selection of the content indicative of that candidate file set.

16. The system of claim 15, wherein the identified candidate file sets include at least one of a frequent file set, a common application package file set, a common version file set, and a common directory file set

17. The system of claim 15, wherein examining comprises constructing a frequent pattern tree representing quantitative information about candidate patterns found within the set of unrecognized files and identifying the candidate file sets that are frequent file sets utilizing the frequent pattern tree.

18. The system of claim 15, identifying the candidate pattern sets comprises identifying candidate pattern sets having a support exceeding a first predetermined threshold and a size exceeding a second predetermined threshold.

19. The system of claim 15, wherein, for each identified candidate pattern file set, the content presented for that candidate pattern set is indicative of at least one of a support and a file set size of the candidate pattern file set.

20. The system of claim 15, wherein the plurality of application files is a first plurality and wherein the method further comprises:
generating a rule based on the association between the application its associated candidate file set; and
processing the rule to automatically associate unrecognized files of a second plurality of application files with the application, the unrecognized files corresponding to one or more files of the corresponding candidate file set.
